(19) United States
(12) Patent Application Publication
(10) Pub. No.: US 2015/0147464 A1
(43) Pub. Date: May 28, 2015

(54) METHOD FOR PRODUCING AN ELECTRODE FOR ELECTROCHEMICAL STORAGE SYSTEMS HAVING ACTIVE MATERIAL SOLUBLE IN THE ELCTROLYTE

(71) Applicant: Robert Bosch GmbH, Stuttgart (DE)

(72) Inventors: Jens Grimminger, Leonberg (DE); Marcus Wegner, Leonberg (DE)

(21) Appl. No.: 14/553,600

(22) Filed: Nov. 25, 2014

(30) Foreign Application Priority Data
Nov. 26, 2013 (DE) 10 2013 224 079.1

(51) Int. Cl. H01M 4/04; H01M 2/14; H01M 4/139

(52) U.S. Cl. CPC H01M 4/0404; H01M 4/139; H01M 2/145
USPC 427/58

(57) ABSTRACT

A method for producing an electrode for electrochemical storage systems includes: applying an electrode slurry onto at least one side of a current collector for the formation of an electrode coating on the current collector, the electrode slurry having at least one active material; and applying an inhibitor material, with a predetermined width, onto adjacent regions of the electrode coating applied on the current collector, the inhibitor material being impermeable to liquid active material and to forms of the active material dissolved in the electrolyte.

### BACKGROUND OF THE INVENTION

1. Field of the Invention

The present invention relates to a method for producing an electrode for electrochemical storage systems having active material soluble in the electrolyte.

2. Description of the Related Art

Due to the high specific capacity of lithium (3862 mAh/g) and sulfur (1672 mAh/g), secondary batteries based on lithium/sulfur are promising solutions for use in electrically operated systems, in particular for use in electrically driven vehicles. However, the inadequate cycle stability of this electrochemical reaction system has until now prevented wide use of this type of accumulator.

In contrast to conventional lithium-ion systems having transition metal oxide cathodes, the overall reaction Li+S₈⇄Li₂S contains a plurality of intermediate stages having different sulfur chain lengths (so-called polysulfides), which have good solubility as a conducting salt in standard electrolyte systems such as DOL (1,3-dioxolane)/DME (dimethoxyethane) with LiTFSI (lithium bis(trifluoromethanesulfonyl)imide). In the course of the cyclization, these polysulfides partly diffuse out from the cathode region, and can then no longer be deposited as lithium sulfide. The cause of this is the depositing of formed lithium sulfide on the surface of the conducting additive; conducting additive regions are then no longer accessible for already-dissolved polysulfides. Incompletely reduced sulfur species are thus left over in the electrolyte at the end of the discharge, causing a reduction in the sulfur utilization. The polysulfides can also diffuse up to the anode, and can react there with elementary lithium on the redox-chemical path to form lithium sulfide. However, this results in a loss of active material, and thus to an undesirable loss of capacity.

According to currently existing art, cathodes are made from a cathode slurry that is applied using a doctor knife onto a current collector foil, standardly made of aluminum, and that is dried there. The cathode slurry is made of a cathode active material, such as sulfur, a conducting additive (for example carbon black, graphite), or also a sulfur conducting additive composite, and typically a binder (such as PVDF, PTFE), as well as a dispersant, such as n-methyl-2-pyrrolidone (NMP).

Given this construction of the electrode, the polysulfides formed during the discharging of the cell can diffuse out from the coating without hindrance (see FIG. 1). This has the consequence that even given the use of membranes or protective layers between a lithium electrode and cathode that are not permeable to the polysulfides, the polysulfides can nonetheless diffuse out from a cell stack, or a cell coil, resulting in a loss of active material and thus an undesirable loss in capacity.

Published German patent application document DE 22 64 579 discloses a galvanic element having a copper sulfide cathode, an anode made of an alkali or earth alkali metal, and an organic solvent as electrolyte bearer, the organic solvent containing, for use as secondary element, dissolved polysulfide in addition to a conducting salt, and the cathode and anode chamber being separated from one another by a semipermeable membrane or cation exchange membrane in such a way that the diffusion of polysulfide into the anode chamber is prevented.

### BRIEF SUMMARY OF THE INVENTION

The present method for producing an electrode for electrochemical storage systems has the advantage that through the use of the present inhibitor material, a lateral diffusing out of the active material dissolved in the electrolyte, in particular parallel to the electrode plane, is prevented. This advantageously results in an increase in the specific energy of the cell, achieved through a higher overall sulfur utilization.

The application of the inhibitor material onto the current collector with a predetermined width can preferably take place in those regions on the side of the electrode coating that are immediately adjacent to the electrode coating. In addition, it is advantageous if the inhibitor material surrounds the entire periphery of the electrode coating. The electrode coating can be formed only on one side of the current collector or on both sides of the current collector. In addition, the present method for producing an electrode for electrochemical storage systems is not limited to a particular reaction system formed by a metal and an active material, such as for example the above-named lithium-sulfur electrode, but rather can also be used in the production of electrodes of all electrochemical storage systems in which a form of the active material (a precursor of the active material, an end product in the discharging of the electrochemical storage system, and an intermediate product in the operation of the electrochemical storage system) is soluble in the electrolyte system.

The core of the present invention is a method for producing an electrode for electrochemical storage systems, in particular a cathode for lithium-sulfur accumulators, in which, through a containment of the loss of active material, a substantial deficit of lithium-sulfur cells according to the currently existing art, namely their low cycle stability, can be significantly corrected. Even given the use of a membrane impermeable to active material, up to now sulfur species can still diffuse out from the cathode chamber, passing by the edge regions, and in some cases can diffuse up to the anode and react there, or can no longer flow back into the cathode chamber. Through the present method, the loss mechanism is limited to a diffusion of polysulfides through the separator of the cell.

According to a further embodiment of the present method, the pre-specified width for the covering of the current collector with the inhibitor material can be between 1 mm and 20 mm. Preferably, the predetermined width for the covering of the current collector with the inhibitor material can be between 1 mm and 5 mm.

According to a further embodiment of the present method, the height of the covering of the current collector with the inhibitor material can be between 30 μm and 120 μm. Alternatively, the height of the covering of the current collector with the inhibitor material can be between 20 μm and 400 μm, in particular between 200 μm and 300 μm or between 300 μm and 400 μm. In addition, the inhibitor material can cover the entire height of the electrode coating.

According to a further embodiment of the present method, in addition a step of drying the electrode slurry applied at least in some regions on at least one side of the current collector can be provided before the application of the inhibitor material. This advantageously enables a broader selection of adhesives that can be used, if the inhibitor material additionally has the adhesive functionality, because the adhesive is not applied until after the drying process of the electrode, and thus the drying process does not have any influence on the adhesive action of the adhesive.

According to a further embodiment of the present method, the active material can be sulfur.

According to a further embodiment of the present method, the inhibitor material can in addition have an adhesive functionality, with the aid of an adhesive. Here, the adhesive functionality is relevant in particular for the sealing of a volume formed in the interior of the cell stack. In addition to the fixing of individual layers of the cell stack, the sealing effect additionally acts to enclose a liquid electrolyte in the cell stack. Thus, in an advantageous manner the danger of a direct short circuit in the production of cell stacks from the present electrodes is reduced, because the separator can be fixed on the electrode already before the stacking process, and thus can no longer slip out of place.

According to a further embodiment of the present method, the application of the adhesive inhibitor material can take place together with the application of the electrode slurry onto the current collector, the adhesive being fashioned such that, after a subsequent step of drying the electrode slurry, the adhesive retains the adhesive functionality. The adhesive can for example be applied onto the current collector together with the electrode slurry, as a contact adhesive. For this purpose, an adhesive must be used that can withstand the subsequent drying process of the electrode without damaging its adhesive effect.

According to a further embodiment of the present method, the adhesive is insoluble in the electrolyte system and is impermeable for forms of the active material dissolved in the electrolyte, such as a precursor of the active material, an end product in the discharging of the electrochemical storage system, and intermediate products in the operation of the electrochemical storage system. In addition, the adhesive is insoluble in the electrolyte system and is impermeable to liquid active material.

According to a further embodiment of the present method, the adhesive can have a physically setting adhesive or a chemically hardening adhesive. For the physically setting adhesives, in particular contact adhesives are preferred, such as adhesives based on polychloroprene and polyurethane. In the class of chemically hardening adhesives, both two-component and one-component systems can be used, for example methyl methacrylate adhesives, radiation-curable adhesives such as UV acrylates, silicones, silane-cross-linked polymer adhesives, epoxy resin adhesives, polyurethane adhesives, and contact adhesives having the required chemical stability.

According to a further embodiment of the present method, in addition the step of applying a separator onto the electrode can be provided that covers both the electrode coating and also, at least in some segments, the region of the adhesive inhibitor material. Thus, in the case of a separator (membrane) impermeable to all forms of the active material, it would be possible to hold all active species in the electrode chamber in the immediate environment of the conductivity additive, so that the loss occurring up to now of active material, and the concomitant undesirable loss of capacity, would be minimized as far as possible, because the diffusion of the active material is then limited to the electrode chamber. In particular, the separator has the function of preventing a diffusing out of the forms of the active material from the region of the electrode coating toward the sides in connection with the adhesive inhibitor material.

Before the fixing of the separator onto the electrode with the adhesive, the electrolyte has to be applied, if the membrane is completely impermeable to the electrolyte. This can for example take place at the same time as the application of the inhibitor material having the adhesive functionality. If, in contrast, the membrane is impermeable to the electrolyte, the electrolyte can also be applied after the fixing of the separator. In particular given the use of polyolefin membranes, the application of an adhesive-promoting agent can be advantageous, such as organically functionalized silanes, metal-organic compounds, in particular titanates and zirconates, and polymers such as polyester and polyethylene imine.

### BRIEF DESCRIPTION OF THE DRAWINGS

FIG. 1 shows a perspective view of an electrode for an electrochemical storage system according to the existing art.

FIG. 2 shows a perspective view of an electrode for an electrochemical storage system that was produced using a method according to the present invention.

### DETAILED DESCRIPTION OF THE INVENTION

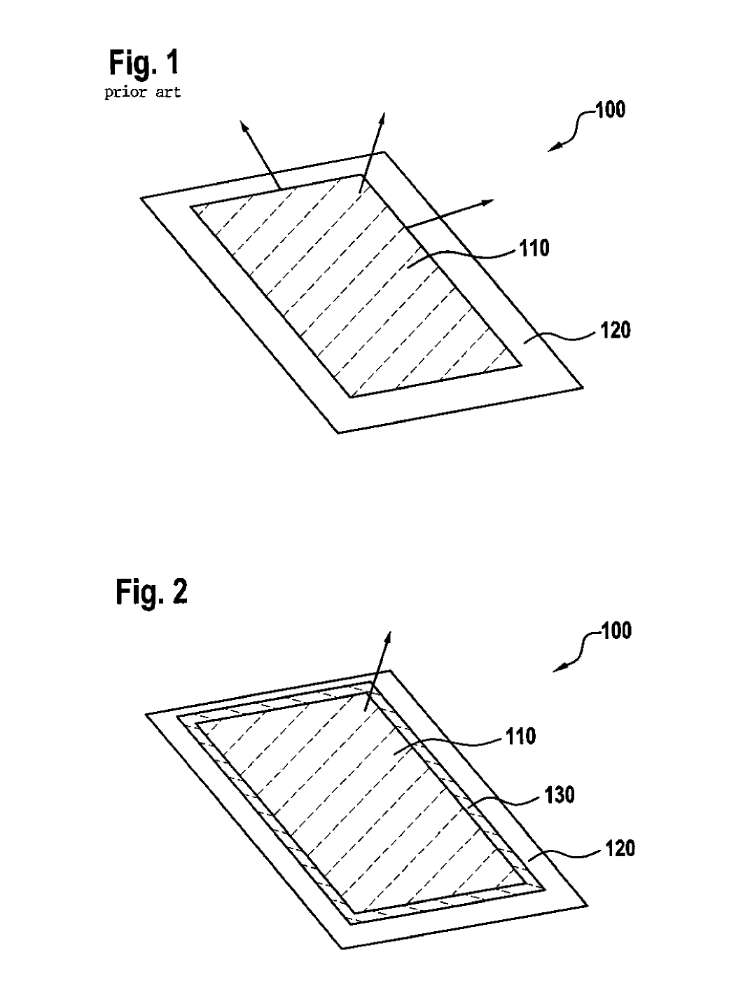

FIG. 1 shows a perspective view of an electrode 100 for an electrochemical storage system according to the existing art. Electrode 100 has a current collector foil 120 that is standardly made of aluminum, onto which an electrode slurry (not shown) is spread with a doctor knife, the slurry then being hardened, after a drying process, to form an electrode coating 110.

A disadvantage of such a realization of electrode 100 is the fact that intermediate stages formed during the discharging (polysulfides are particularly relevant here), or the end product of the active material can diffuse out unhindered in all directions from electrode coating 110 (see the corresponding arrows in FIG. 1). This has the consequence that even given the use of membranes (not shown) or protective layers (not shown) between the metallic electrode and the cathode that are impermeable to the polysulfides, the polysulfides can nonetheless diffuse out from a cell stack or from a cell coil parallel to the planes of the anode (lithium)-separator-cathode composite, causing a loss of active material and thus an undesirable loss of capacity.

FIG. 2 shows a perspective view of an electrode 100 for an electrochemical storage system that was produced using a method according to the present invention. In the following, an electrode 100 is described for a reaction system of a cell (not shown), using lithium as anode material and using sulfur as cathode material. Here, for the production of electrode 100, first an electrode slurry (not shown) is produced that can be made up for example of 60% sulfur, 30% conducting additive, and 10% binder in n-methyl-2-pyrrolidone (NMP). The production of the slurry for electrode 100 does not differ from conventional production methods for electrodes containing sulfur. Subsequently, the electrode slurry is applied in some regions on one side or on both sides of a current collector 120 realized as a foil.

There then takes place the step of application of an inhibitor material 130 on adjacent regions of electrode coating 110 applied on current collector 120 with a predetermined width, inhibitor material 130 being impermeable to forms of the active material dissolved in the electrolyte, such as a precursor of the active material, an end product in the discharge of the electrochemical storage system, and intermediate products in operation of the electrochemical storage system. Inhibitor material 130 is applied onto current collector 120 so as to be sealed around the spread-on electrode slurry, which can take place either together with the application of the electrode slurry onto current collector 120 or after a step of drying of the electrode slurry applied in some regions. The predetermined width for the covering of current collector 120 with inhibitor material 130 is preferably between 1 mm and 20 mm, and the height of the covering of current collector 120 with inhibitor material 130 is between 20 μm and 400 μm, preferably between 30 μm and 120 μm.

Inhibitor material 130 has in addition an adhesive functionality with the aid of an adhesive (not shown), and the adhesive is insoluble in the electrolyte system and is impermeable to liquid active material as well as to forms of the active material dissolved in the electrolyte, such as a precursor of the active material, an end product in the discharge of the electrochemical storage system, and intermediate products in the operation of the electrochemical storage system. Here, the adhesive can have a physically setting adhesive or a chemically hardening adhesive. In the case of the physically setting adhesives, in particular contact adhesives are preferred, such as adhesives based on polychloroprene and polyurethane. In the class of the chemically hardening adhesives, both two-component and one-component systems can be used, such as for example methyl methacrylate adhesives, radiation-curable adhesives such as UV acrylates, silicones, silane-cross-linked polymer adhesives, epoxy resin adhesives, polyurethane adhesives, and contact adhesives having the required chemical stability.

The present method for producing electrode 100 for electrochemical storage systems has in this way the advantage that through the use of the present inhibitor material 130 a lateral diffusing out of the active material dissolved in the electrolyte, in particular parallel to the electrode plane, is prevented. From this there then advantageously results an increase in the specific energy of the cell, achieved through a higher overall sulfur utilization. In this way, given such a realization of electrode 100 the active material formed during the discharge can diffuse out from electrode coating 110 only perpendicular thereto (see the corresponding arrow in FIG. 2).

What is claimed is:

1. A method for producing an electrode for an electrochemical storage system, comprising:
(a) applying an electrode slurry onto at least one side of a current collector to form an electrode coating on the current collector, the electrode slurry having at least one active material;
(b) applying an inhibitor material, with a predetermined width, onto adjacent regions of the electrode coating applied on the current collector, the inhibitor material being impermeable to liquid active material and to forms of the active material dissolved in the electrolyte, including a precursor of the active material, an end product in the discharge of the electrochemical storage system, and intermediate products in the operation of the electrochemical storage system.

2. The method as recited in claim 1, wherein the predetermined width for the covering of the current collector with the inhibitor material is in the range of 1 mm to 20 mm.

3. The method as recited in claim 2, wherein the height of the inhibitor material covering the current collector is in the range of 30 μm to 120 μm.

4. The method as recited in claim 1, further comprising:
drying the electrode slurry applied on at least one side of the current collector, before the application of the inhibitor material.

5. The method as recited in claim 4, wherein the active material is sulfur.

6. The method as recited in claim 5, wherein the inhibitor material in addition has an adhesive functionality.

7. The method as recited in claim 6, wherein the application of the adhesive inhibitor material takes place together with the application of the electrode slurry onto the current collector, wherein the adhesive inhibitor material retains the adhesive functionality after the drying of the electrode slurry.

8. The method as recited in claim 6, wherein the adhesive inhibitor material is insoluble in the electrolyte system.

9. The method as recited in claim 8, wherein the adhesive inhibitor material has one of a physically setting adhesive or a chemically hardening adhesive.

10. The method as recited in claim 8, further comprising:
applying a separator onto the electrode, the separator covering both (i) the electrode coating and (ii) at least some segments of the adhesive inhibitor material.
